(19) United States
(12) Patent Application Publication
(10) Pub. No.: US 2024/0130296 A1
(43) Pub. Date: Apr. 25, 2024

(54) DEVICE FOR GATHERING AND CUTTING VEGETATION

(71) Applicant: Woods-N-Water, Inc., Sandersville, GA (US)

(72) Inventor: Blaine Burley, Tennille, GA (US)

(21) Appl. No.: 18/383,541

(22) Filed: Oct. 24, 2023

Related U.S. Application Data
(60) Provisional application No. 63/419,173, filed on Oct. 25, 2022.

(51) Int. Cl. A01G 3/08

(52) U.S. Cl. CPC A01G 3/088

(57) ABSTRACT

A device adapted for gathering and cutting vegetation includes a support, a vegetation cutter carried on the support and a vegetation gatherer carried on the support. The vegetation gatherer is adapted to (a) gather vegetation, such as a plurality of limbs, and (b) direct the gathered vegetation into the vegetation cutter for cutting.

### RELATED APPLICATION

This document claims priority to U.S. Provisional Patent Application Ser. No. 63/419,173, filed on Oct. 25, 2022, the full disclosure of which is hereby incorporated by reference in its entirety.

### TECHNICAL FIELD

This document relates generally to equipment used to keep roadways, trails, and walking paths cleared for use. More specifically, the vegetation gathering and cutting device disclosed herein increases efficiency by drawing a relatively large area of vegetation, such as brush and/or tree limbs, into a central cutting device.

### BACKGROUND

Limb and brush trimming equipment is used extensively by those who own or manage land intended for outdoor activities. After roadways, trails, or walking paths are put in service, tree limbs and brush naturally grow into the open area and must periodically be trimmed to maintain usability. A solution recently patented for those owning large equipment that accept front end hydraulic attachments is a cutting deck that is adjustable from a horizontal to a vertical position and positions in between (U.S. Ser. No. 10/470,364B1).

While this is a viable solution, many landowners/managers do not own equipment to accept this type of attachment or prefer to undertake this task, typically performed only once or twice a year, in a more economical fashion. Equipment typically used for this task come in many forms, but generally include a cutting device such as a chain saw or circular brush cutter and are either gas or electrically powered. To reach elevated vegetation, equipment is available in extended versions such as the commonly available “pole saw”.

Even when powered equipment is used, clearing a roadway or trail is a laborious task and requires a significant amount of manpower. Devices to mount this power equipment to wheeled vehicles are well known and with the proper actuation mechanism operator effort can be reduced significantly. The progress is still relatively slow and requires a great deal of articulating the cutting device to remove debris which grows at varying heights. There exists a need for an attachment that, when coupled with the current technology, can further reduce the operator effort and overall time required to trim debris at varying heights.

### SUMMARY

In accordance with the purposes and benefits set forth herein, a new and improved device is provided for gathering and cutting vegetation, including brush and tree limbs. The device comprises, consists or consists essentially of: (a) a support, (b) a vegetation cutter carried on the support, and (c) a vegetation gatherer carried on the support and adapted to (i) gather vegetation, such as brush and/or a plurality of limbs, and (ii) direct the gathered vegetation into the vegetation cutter for cutting. The device is particularly suited or adapted for directing vegetation into a central vegetation cutter as it moves forward along a path, trail, roadway or other avenue so that the path, trail, roadway or other avenue may be kept clear of vegetation and open for use.

In at least one of the many possible embodiments of the device, the vegetation gatherer includes a first arm and a second arm defining a feed channel having an inlet end and a cutter end adjacent the vegetation cutter. That feed channel may be configured to converge from the inlet end to the cutter end. In such embodiments, the first arm and the second arm may define an included angle of between about 5 and about 80 degrees.

In at least some embodiments of the device, the device further includes (a) a cutter housing carried on the support about at least a portion of the vegetation cutter, (b) a first pivot pin pivotally connecting a proximal end of the first arm to the cutter housing and (c) a second pivot pin pivotally connecting a proximal end of the second arm to the cutter housing.

In at least some of the many possible embodiments of the device, the device includes an angle guide carried on the cutter housing and adapted for adjusting the included angle between the first arm and the second arm. The angle guide may include (a) a first arcuate slot formed in a wall of the cutter housing, (b) a second arcuate slot formed in the wall of the cutter housing, (c) a first fastener releasably connecting the first arm to the cutter housing at the first arcuate slot, and (d) a second fastener releasably connecting the second arm to the cutter housing at the second arcuate slot.

In at least some embodiments of the device, the first arm and the second arm are length adjustable. More specifically, (a) a first plurality of length adjustment apertures may be provided in the first arm and (b) a second plurality of length adjustment apertures may be provided in the second arm.

The device may further include a cutter housing carried on the support about at least a portion of the vegetation cutter. The cutter housing may include (a) a first locking pin receiver and a second locking pin receiver, (b) a first locking pin received through one of the first plurality of length adjustment apertures in the first arm and the first locking pin receiver and (c) a second locking pin received through one of the second plurality of length adjustment apertures in the second arm and the second locking pin receiver.

In at least one of the many possible embodiments of the device, the support includes a base, a post carried on the base, a telescoping extension arm and an angle adjuster adapted to connect the telescoping extension arm to the post at a selected angle. The angle adjuster may further include an angle guide. That angle guide may include a plurality of pin receivers, an angle pin receiver in the telescoping extension arm and an angle pin received in one of the plurality of pin receivers and the angle pin receiver.

In at least some embodiments, the vegetation cutter includes a rotary blade partially enclosed by a cutter housing. The vegetation cutter may further include a drive motor adapted for driving the rotary blade. That drive motor may be carried on an end of the telescoping extension arm opposite the rotary blade.

In the following description, there are shown and described several different embodiments of the new and improved device adapted for gathering and cutting limbs. As it should be realized, the device is capable of other, different embodiments and its several details are capable of modification in various, obvious aspects all without departing from the device as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein by reference and forming a part of the specification, illustrate several aspects of the new and improved device adapted for gathering and cutting vegetation and together with the description serve to explain certain principles thereof.

FIG. 1 is a perspective view of the new and improved device adapted for gathering and cutting vegetation, such as brush, limbs and the like.

FIG. 2 is a detailed perspective view of the vegetation cutter and vegetation gatherer of the device illustrated in FIG. 1.

FIG. 3 is a detailed plan view of the vegetation gatherer illustrating the arms of the vegetation gatherer in relatively open and relatively closed positions with the arms providing a feed channel that converges from an open inlet end toward a cutter end adjacent the vegetation cutter.

FIG. 4 is a detailed perspective view illustrating one possible embodiment of the device incorporating length adjustable arms wherein the arms are shown in a fully extended position.

FIG. 5 is a detailed plan view similar to FIG. 4 but showing the arms in a fully retracted position.

Reference will now be made in detail to the present preferred embodiments of the device.

### DETAILED DESCRIPTION

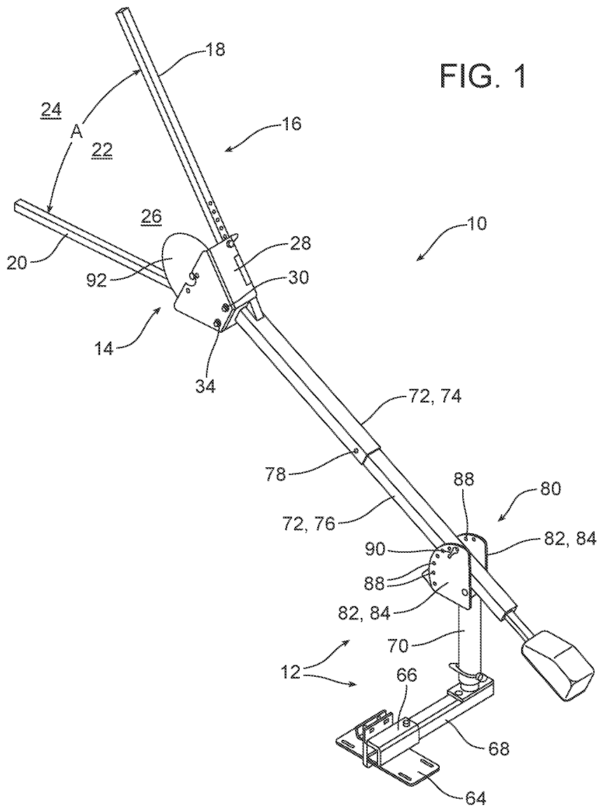

Reference is now made to FIGS. 1-5 illustrating a new and improved device 10 adapted for gathering and cutting vegetation, such as brush and tree limbs, growing alongside paths, trails, roadways and other avenues that must be kept clear of such vegetation to accommodate and enjoy their full and proper use. As best shown in FIG. 1, the device 10 includes (a) a support 12, (b) a vegetation cutter 14 carried on the support, and (c) a vegetation gatherer 16 carried on the support and adapted to (i) gather vegetation, such as a plurality of limbs, and (ii) direct the gathered vegetation into the vegetation cutter for cutting. The device 10 is particularly suited or adapted for (a) mounting on a motorized maintenance vehicle such as a tractor, all-terrain vehicle or cart, and (b) directing vegetation into the centrally located cutter 14 as the motorized maintenance vehicle moves forward along a path, trail, roadway or other avenue so that the path, trail, roadway or other avenue may be kept clear of vegetation and fully open for use.

In at least one of the many possible embodiments of the device 10, the vegetation gatherer 16 includes a first arm 18 and a second arm 20 defining a feed channel 22 having an open inlet end 24 and a cutter end 26 adjacent the vegetation cutter 14. That feed channel 22 may be configured to converge from the inlet end 24 to the cutter end 26. In such embodiments, the first arm 18 and the second arm 20 may define an included angle A of between about 5 and about 80 degrees.

In the illustrated embodiment, the device 10 further includes a cutter housing 28 carried on the support 12 about at least a portion of the vegetation cutter 14. A first pivot pin 30 pivotally connects a proximal end of the first arm 18 to the cutter housing 28 and a second pivot pin 34 pivotally connects a proximal end of the second arm 20 to the cutter housing.

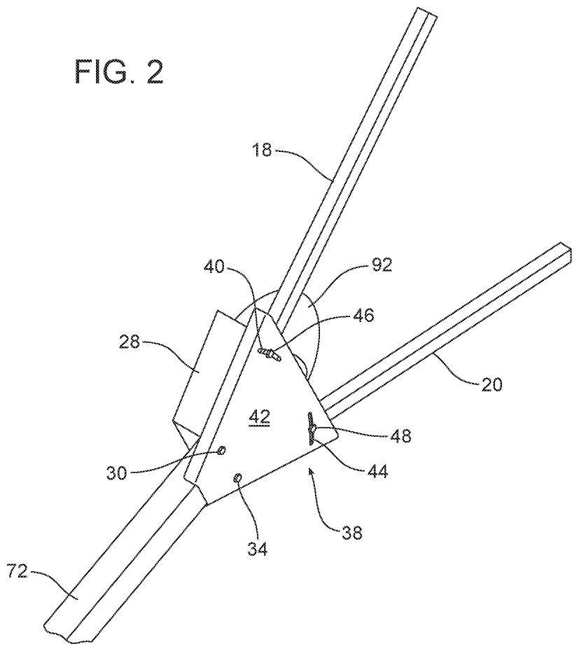

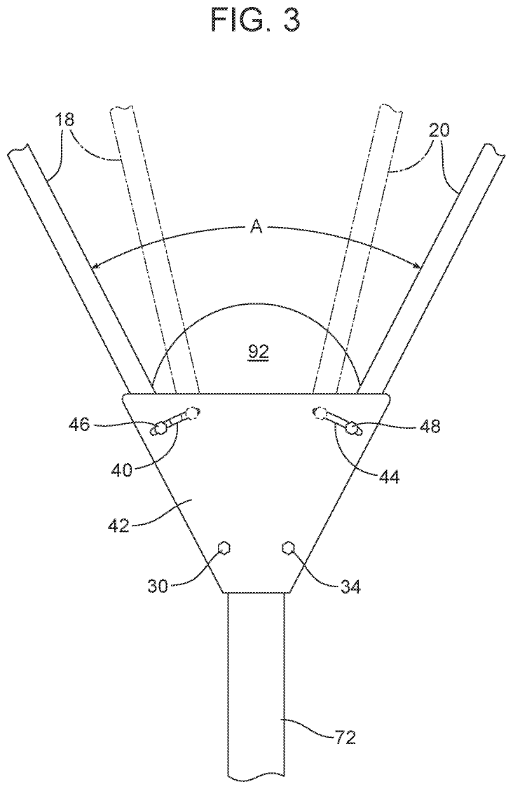

As best shown in FIGS. 2 and 3, the device 10 includes an angle guide, generally designated by reference numeral 38, that is carried on the cutter housing 28 and adapted for adjusting the included angle A between the first arm 18 and the second arm 20. The angle guide 38 shown in FIGS. 2 and 3 includes (a) a first arcuate slot 40 formed in a wall 42 of the cutter housing 28, (b) a second arcuate slot 44 formed in the wall of the cutter housing, (c) a first fastener 46 releasably connecting the first arm 18 to the cutter housing at the first arcuate slot, and (d) a second fastener 48 releasably connecting the second arm 20 to the cutter housing at the second arcuate slot.

In order to adjust the included angle A between the two arms 18, 20, one first loosens the fastener 46 to adjust the angular position of the first arm 18 and/or loosens the fastener 48 to adjust the angular position of the second arm 20. When the respective fastener 46, 48 is loosened, one may grasp the distal end of the arm 18 or 20 to make the adjustment. More particularly, one may pivot the first arm about the first pivot pin 30 and/or the second arm 20 about the second pivot pin 34 to make angular adjustments within the range of adjustment allowed by the first and second arcuate slots 40, 44. After the desired angular adjustment has been made to the arm or arms 18, 20, the respective fasteners 46 and 48 are once again tightened to hold the arms in the desired angular positions. For example, the two arms 18, 20 may be opened wide to provide an included angle of about 55° as shown in full line and closed down to provide an included angle of about 30° as shown in phantom line in FIG. 3. As should be appreciated, the greater the included angle A, the greater the area of limbs and brush gathered by the arms 18, 20 and directed into the vegetation cutter 14.

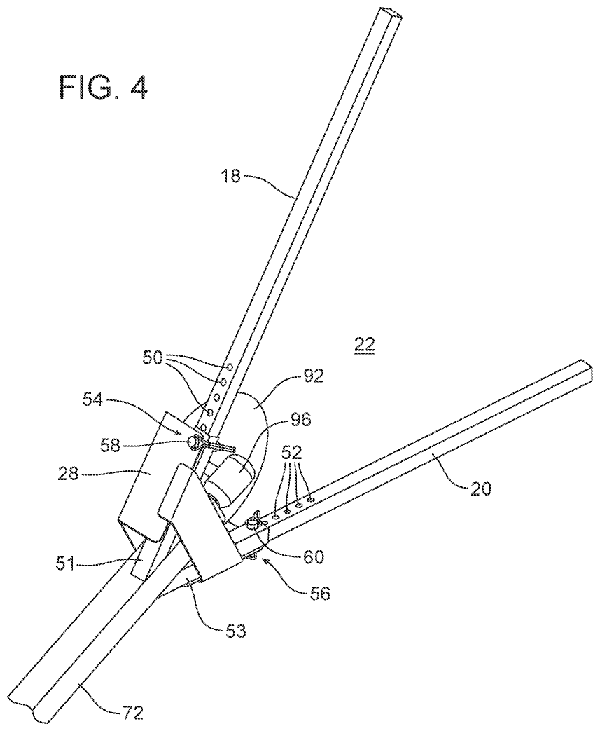

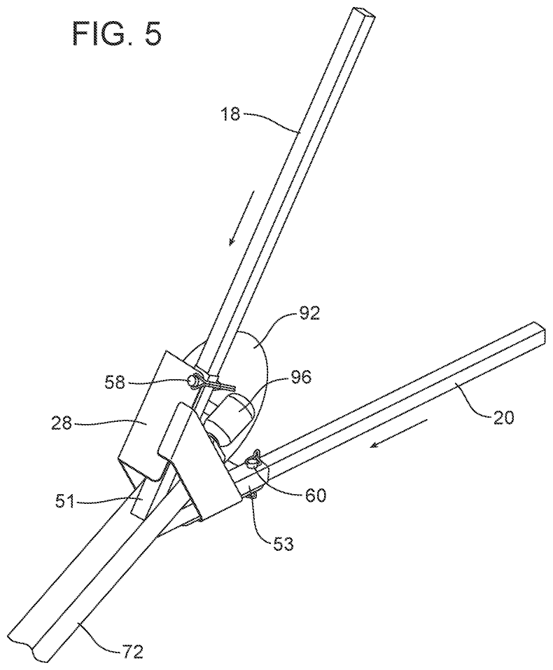

As best shown in FIGS. 4 and 5, the first arm 18 and the second arm 20 of this illustrated embodiment are length adjustable. More specifically, the first arm 18 is held in a first sleeve or receiver 51 while the second arm 20 is held in a second sleeve or receiver 53. Both receivers 51 and 53 may be fixed to the cutter housing 28. The first arm 18 slides freely in the receiver 51 and the second arm 20 slides freely in the receiver 53. A first plurality of length adjustment apertures 50 may be provided in the first arm 18 and a second plurality of length adjustment apertures 52 may be provided in the second arm 20.

The cutter housing 28 and the first sleeve or receiver 51 includes (a) a first locking pin receiver 54. In addition, the cutter housing 28 and the second sleeve or receiver 53 includes a second locking pin receiver 56. One slides the first arm 18 in and out of the first receiver 51 and the second arm in and out of the second receiver 53 to adjust the length of the arms. A first locking pin 58 is then inserted through a selected one of the first plurality of length adjustment apertures 50 in the first arm 18 and the first locking pin receiver 54 to secure the first arm 18 at a selected length. Similarly, a second locking pin 60 is inserted through a selected one of the second plurality of length adjustment apertures 52 in the second arm 20 and the second locking pin receiver 56 to secure the second arm 20 at a selected length. FIG. 4 shows the two arms 18, 20 in the fully extended position. In contrast, FIG. 5 shows the two arms 18, 20 in the fully retracted position (note action arrows).

In other possible embodiments, arm length adjustment is provided by other means. For example, each arm 18, 20 could be made from two sliding pieces to allow for telescoping action in a manner known in the art.

As best shown in FIG. 1, the support 12 may include a base 64 adapted for securing to a motorized maintenance vehicle such as a tractor, all-terrain vehicle or cart (not shown). The base 64 may include a receiver 66 adapted to receive and hold a lateral extension arm 68 of any desired or even adjustable length. A post 70 is mounted on the extension arm 68 and carried on the base 64. The post 70 may also be telescoping and adjustable in length.

As shown in FIG. 1, the support 12 also includes a telescoping extension arm 72 (note first section 74 received for sliding movement over the second section 76 and releasably held in place by a locking pin 78 in a manner known in the art) and an angle adjuster 80 adapted to connect the telescoping extension arm to the post at a selected angle. The angle adjuster 80 includes an angle guide 82 including two upright plates 84 that are spaced to form a trunnion for receiving the extension arm 72. Each plate 84 includes a plurality of pin receivers 88 allowing for angular adjustment of the extension arm 72. An angle pin 90 passing through (a) an angle pin receiver (not shown) in the telescoping extension arm 72 and (b) aligned pin receivers 88 in the plates 84 functions to hold the extension arm at the desired operating angle.

The vegetation cutter 14 may comprise substantially any device known in the art and adapted for cutting vegetation such as tree limbs. In the illustrated embodiment, the vegetation cutter 14 includes a rotary blade 92 partially enclosed by a cutter housing 28. The vegetation cutter 14 may further include a power head 94, of a type known in the art, adapted for driving the rotary blade 92. That power head 94 may be carried on an end of the telescoping extension arm 72 opposite the rotary blade 92 to help counterbalance the entire extension arm 72 and the components on the opposite end thereof. In one possible embodiment, a flexible drive shaft (not shown) may be provided to connect the power head 94 to the rotary blade 92. Such a flexible drive shaft may extend through the telescoping extension arm 72 between the power head 94 and a transmission 96 near the rotary blade 92.

Each of the following terms written in singular grammatical form: “a”, “an”, and “the”, as used herein, means “at least one”, or “one or more”. Use of the phrase “One or more” herein does not alter this intended meaning of “a”, “an”, or “the”. Accordingly, the terms “a”, “an”, and “the”, as used herein, may also refer to, and encompass, a plurality of the stated entity or object, unless otherwise specifically defined or stated herein, or, unless the context clearly dictates otherwise. For example, the phrase: “a blade”, as used herein, may also refer to, and encompass, a plurality of blades.

Each of the following terms: “includes”, “including”, “has”, “having”, “comprises”, and “comprising”, and, their linguistic/grammatical variants, derivatives, or/and conjugates, as used herein, means “including, but not limited to”, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof.

The phrase “consisting of”, as used herein, is closed-ended and excludes any element, step, or ingredient not specifically mentioned. The phrase “consisting essentially of”, as used herein, is a semi-closed term indicating that an item is limited to the components specified and those that do not materially affect the basic and novel characteristic(s) of what is specified.

Terms of approximation, such as the terms about, substantially, approximately, etc., as used herein, refers to ±10% of the stated numerical value.

Although the device for gathering and cutting vegetation of this disclosure has been illustratively described and presented by way of specific exemplary embodiments, and examples thereof, it is evident that many alternatives, modifications, or/and variations, thereof, will be apparent to those skilled in the art. For example, the sleeves 51, 53 of the embodiment shown in FIGS. 4 and 5 may be pivotally connected to the cutter housing 28 by pivot pins instead of fixed to that housing. This would allow the arms 18, 20 to accommodate both length and angular adjustment. It is intended that all such alternatives, modifications, or/and variations, fall within the spirit of, and are encompassed by, the broad scope of the appended claims.

What is claimed:

1. A device adapted for gathering and cutting vegetation, comprising:
a support;
a vegetation cutter carried on the support; and
a vegetation gatherer carried on the support and adapted to (a) gather vegetation and (b) direct the gathered vegetation into the vegetation cutter for cutting.

2. The device of claim 1, wherein the vegetation gatherer includes a first arm and a second arm defining a feed channel having an inlet end and a cutter end adjacent the vegetation cutter.

3. The device of claim 2, wherein the feed channel converges from the inlet end to the cutter end.

4. The device of claim 3, wherein the first arm and the second arm define an included angle of between about 5 and about 80 degrees.

5. The device of claim 3, further including (a) a cutter housing carried on the support about at least a portion of the vegetation cutter, (b) a first pivot pin pivotally connecting a proximal end of the first arm to the cutter housing and (c) a second pivot pin pivotally connecting a proximal end of the second arm to the cutter housing.

6. The device of claim 5, further including an angle guide carried on the cutter housing and adapted for adjusting the included angle between the first arm and the second arm.

7. The device of claim 6, wherein the angle guide includes (a) a first arcuate slot formed in a wall of the cutter housing, (b) a second arcuate slot formed in the wall of the cutter housing, (c) a first fastener releasably connecting the first arm to the cutter housing at the first arcuate slot, and (d) a second fastener releasably connecting the second arm to the cutter housing at the second arcuate slot.

8. The device of claim 2 wherein the first arm and the second arm are length adjustable.

9. The device of claim 8, wherein (a) a first plurality of length adjustment apertures are provided in the first arm and (b) a second plurality of length adjustment apertures are provided in the second.

10. The device of claim 9 further including (a) a cutter housing carried on the support about at least a portion of the vegetation cutter, said cutter housing including a first locking pin receiver and a second locking pin receiver, (b) a first locking pin received through one of the first plurality of length adjustment apertures in the first arm and the first locking pin receiver and (c) a second locking pin received through one of the second plurality of length adjustment apertures in the second arm and the second locking pin receiver.

11. The device of claim 1, wherein the support includes a base, a post carried on the base, a telescoping extension arm and an angle adjuster adapted to connect the telescoping extension arm to the post at a selected angle.

12. The device of claim 11, wherein the angle adjuster further includes an angle guide including a plurality of pin receivers, an angle pin receiver in the telescoping extension arm and an angle pin received in one of the plurality of pin receivers and the angle pin receiver.

13. The device of claim 12, wherein the vegetation cutter includes a rotary blade partially enclosed by a cutter housing.

14. The device of claim 13, wherein the vegetation cutter further includes a power head adapted for driving the rotary blade.

15. The device of claim 14, wherein the drive motor is carried on an end of the telescoping extension arm opposite the rotary blade.

16. The device of claim 15, wherein the flexible drive shaft extends through the telescoping extension arm between the drive motor and the rotary blade.

17. The device of claim 1, wherein the vegetation cutter includes a rotary blade partially enclosed by a cutter housing.

18. The device of claim 17, wherein the vegetation cutter further includes a power head adapted for driving the rotary blade and wherein the drive motor is carried on an end of the telescoping extension arm opposite the rotary blade.

19. The device of claim 2, wherein the first arm and the second arm are adapted for angular adjustment.

20. The device of claim 19, wherein the first arm and the second arm are adapted for length adjustment.
